(19) United States
(12) Patent Application Publication
(10) Pub. No.: US 2007/0127984 A1
(43) Pub. Date: Jun. 7, 2007

(54) Coupling structure of board-shaped materials

(76) Inventor: Rex Kuo, Chiai City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/295,586

(22) Filed: Dec. 7, 2005

(51) Int. Cl. F16D 1/00

(52) U.S. Cl. 403/408.1

(57) ABSTRACT

A coupling has a fastening section held in a hole of a first board-shaped material, a fixing section held in a holding hole of a second board-shaped material, and two detaining sides on two ends of the fastening section, which are tightly pressed against respective ones of two sides of the first board-shaped material; the fixing section has several flat ringed parts encompassing and spaced along it, which are slightly wider than the holding hole, therefore the fixing section will be tightly held in the holding hole; the first detaining side includes a belt-shaped plate part, which encompasses the fastening section, and has first and second ends, between which a gap exists; in assembling, the coupling is held in such a position as not to be perpendicular to the first board-shaped material for allowing the first detaining side to pass through the hole of the first board-shaped material.

### BACKGROUND OF THE INVENTION

1. Field of the Invention

The present invention relates to a coupling structure of board-shaped materials, more particularly one, which includes coupling elements each having only one part, and which is rapid to assemble.

2. Brief Description of the Prior Art

Board-shaped materials are among major parts of household and office furniture, which are usually joined together by means of coupling elements.

Referring to FIGS. 1 and 2, a currently existing coupling for joining first and second board-shaped materials 95 and 94 includes a gripping ring 91, a connecting member 92, and several staples 93. The gripping ring 91 has a ring-shaped portion 911, ears 912 projecting from an outward edge of the ring-shaped portion 911, and several thorn portions 913 projecting from an inward edge and inwards towards a central axis of the ring-shaped portion 911. The connecting member 92 has a head 921, and a post-shaped portion 922 extending from the head 921. The first board-shaped material 95 has several holding holes 941 while the second board-shaped material 94 has several through holes 951 thereon. In joining the first and the second board-shaped materials 95 and 94, first the gripping ring 91 is nailed to the second board-shaped material 94 with the thorn portions 913 being held in one of the holding holes 941 by means of the staples 93, which are tightly pressed against respective ones of the ears 912. Second, the connecting member 92 is tightly passed through one of the through holes 951 of the first board-shaped material 95 at the post-shaped portion 922. Finally, the board-shaped materials 95 and 94 are coupled with the post-shaped portion 922 of the connecting member 92 being tightly inserted into the space defined by the thorn portions 913 of the gripping ring 91; thus, the thorn portions 913 prevent the connecting member 92 from falling off, and the first and the second board-shaped materials 95 and 94 are secured together.

The above coupling structure has the following disadvantages:

The holding holes of the second board-shaped material have to have a relatively large diameter for holding the thorn portions, which project towards the central axis of the post-shaped portion of the gripping ring. Therefore, the second board-shaped material is more prone to crack owing to existence of the holding holes, which will cause reduction in strength. Second, the staples 93 are prone to cause injury when the assembling man is fitting the staples 93 to the board-shaped material. Third, if the post-shaped portion 922 of the connecting member 92 isn't aligned with the central axis of the gripping ring 91 after the first and the second board-shaped materials are positioned together, the assembling man has to take the trouble to make modification to the holding hole 941, otherwise the connecting member 92 won't be securely joined to the gripping ring 91. Therefore, it takes relatively much time and labor to couple the board-shaped materials.

### SUMMARY OF THE INVENTION

It is a main object of the invention to provide a coupling structure of board-shaped materials, which is easy and rapid to assemble.

It is a secondary object of the invention to provide a coupling structure of board-shaped materials, which eliminates the need for modification to the connecting holes of the board-shaped materials.

A coupling is used in the coupling structure of the present invention, which has a fastening section held in a hole of a first board-shaped material, a fixing section held in a holding hole of a second board-shaped material, and two detaining sides formed on two ends of the fastening section and tightly pressed against respective ones of two sides of the first board-shaped material. The fixing section has several flat ringed parts encompassing and spaced along it, which are slightly wider than the holding hole, therefore the fixing section will be tightly held in the holding hole. The first detaining side includes a belt-shaped plate part, which encompasses the fastening section, and has first and second ends, between which a gap exists. In assembling, the coupling is held in such a position as not to be perpendicular to the first board-shaped material for allowing the first detaining side to pass through the hole of the first board-shaped material.

### BRIEF DESCRIPTION OF THE DRAWINGS

The present invention will be better understood by referring to the accompanying drawings, wherein:

FIG. 1 is an exploded perspective view of the currently existing coupling structure of board-shaped materials,

FIG. 2 is a section of the currently existing coupling structure,

FIG. 3 is an exploded perspective view of the first preferred embodiment of a coupling structure of board-shaped materials,

FIG. 4 is a partial perspective view of the first embodiment in assembly (1),

FIG. 5 is a partial perspective view of the first embodiment in assembly (2),

FIG. 6 is a sectional view of the first preferred embodiment,

FIG. 7 is a perspective view of another form of coupling in the first preferred embodiment,

FIG. 8 is an exploded perspective view of the second embodiment,

FIG. 9 is a sectional view of the second preferred embodiment, and

FIG. 10 is a sectional view of the third preferred embodiment.

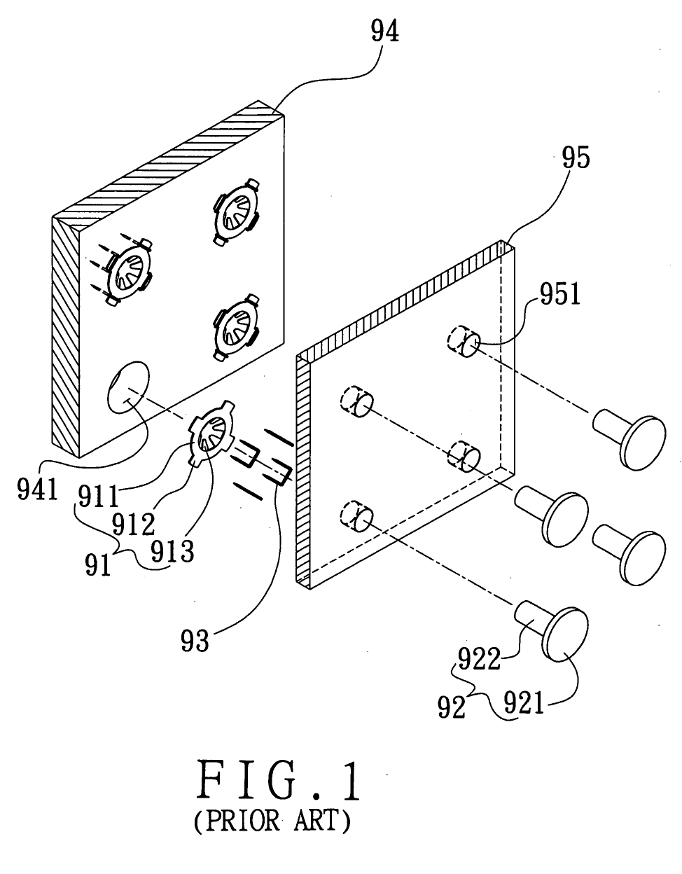

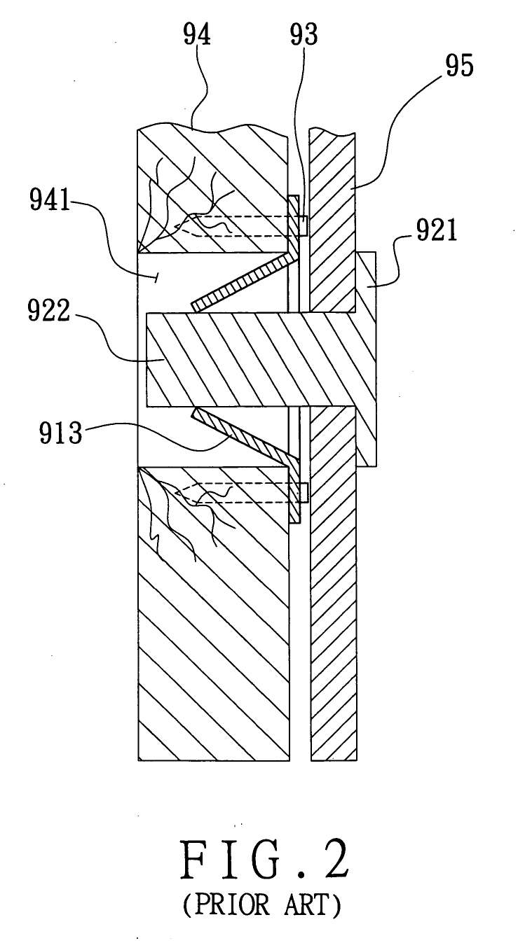

### DETAILED DESCRIPTION OF THE PREFERRED EMBODIMENTS

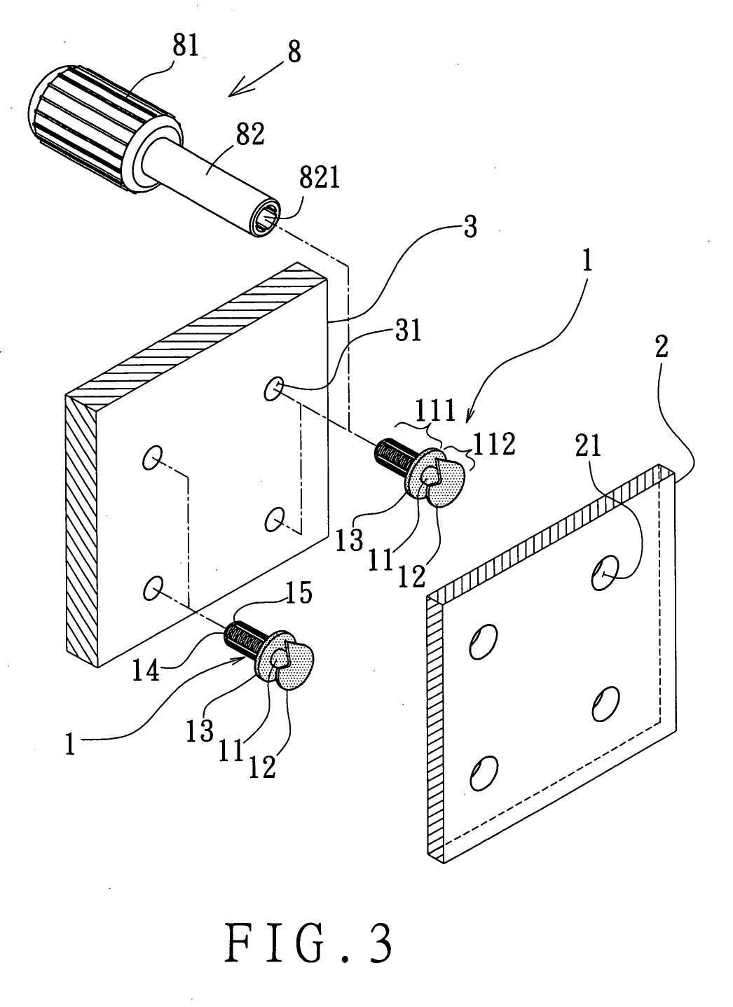

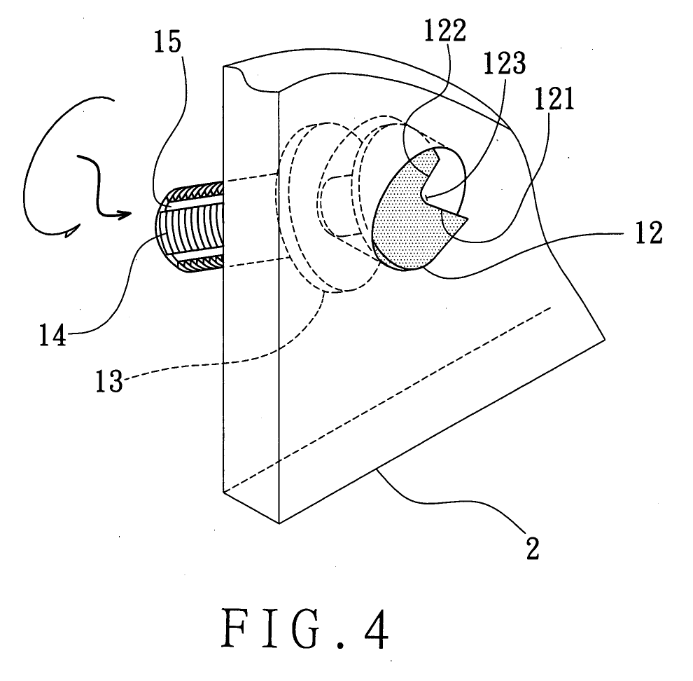

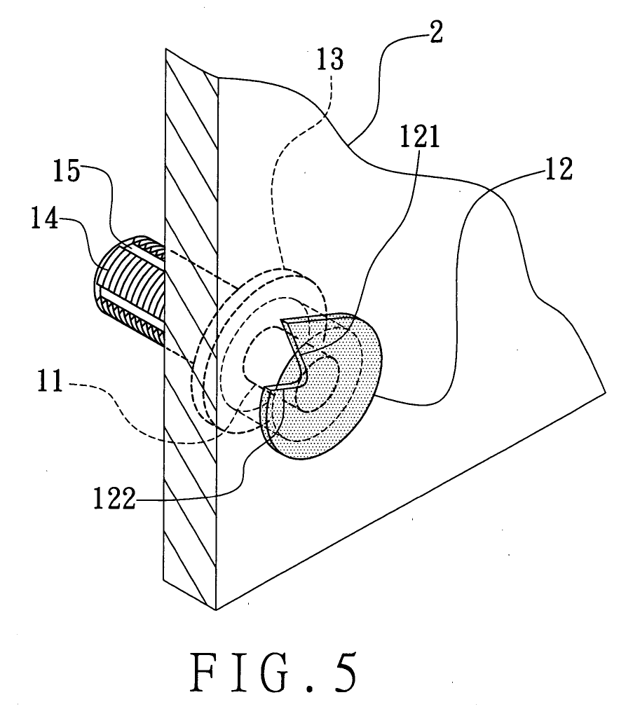

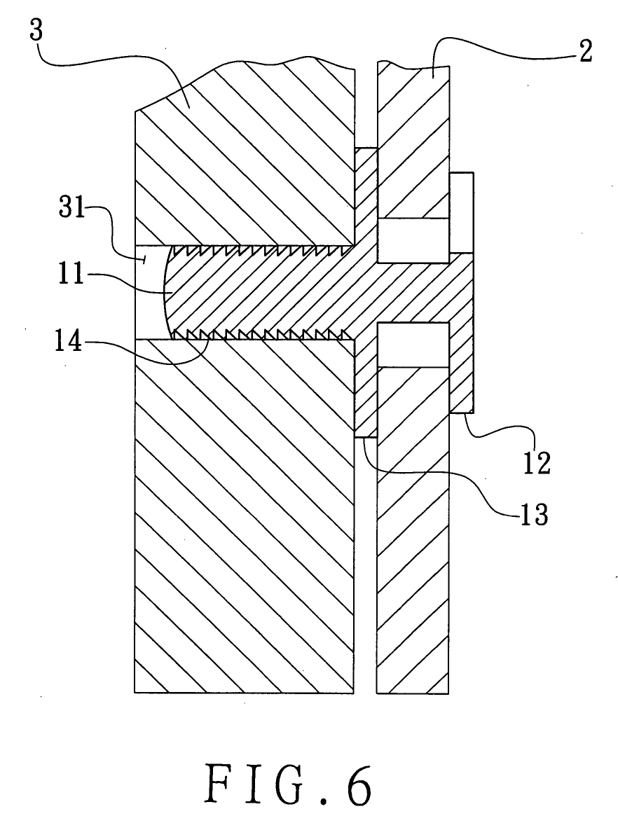

Referring to FIGS. 3 to 6, a first preferred embodiment of a coupling 1 for joining two board-shaped materials in the present invention has a post-shaped part 11. The post-shaped part 11 includes a fixing section 111, and a fastening section 112.

A first detaining side 12 is formed on one end of the fastening section 112 of the post-shaped part 11, and a second detaining side 13 is formed on the other end of the fastening section 112; thus, a holding space exists between the first and the second detaining sides 12 and 13. The first detaining side 12 consists of a belt-shaped plate part, which encompasses the post-shaped part 11, and has first and second ends 121 and 122; there is a gap 123, which is an acute angle, between the first and the second ends 121 and 122; the first end 121 has a greater width than the second end 122. The second detaining side 13 is flat and ring-shaped, and encompasses the post-shaped part 11 in such a way that it is perpendicular to the axis of the post-shaped part 11. In the first preferred embodiment of the present invention, which is shown in FIGS. 3 to 6, the second detaining side 13 is formed on the joined between the fixing section 111 and the fastening section 112, and the first detaining side 12 is apart from the fixing section 111.

The fixing section 111 of the post-shaped part 11 has several flat ringed parts 14 encompassing and spaced along it, and each of the encompassing flat ringed parts 14 has several gaps thereon; thus, the coupling 1 has several axial trenches 15 on the fixing section 111; in the present embodiment, the number of the axial trenches 15 is four.

The coupling 1 of the present invention is further equipped with a handle member 8, which includes a grip portion 81, and a connecting portion 82 having a cave end 821; thus, the coupling 1 can be securely connected to the handle member 8 by means of inserting the fixing section 111 into the cave end 821 of the handle member 8, thus allowing the user to exert force on the coupling 1 with ease.

In using the coupling 1 to join first and second board-shaped materials 2 and 3 together, which have several through holes 21, and several holding holes 31 respectively, first the user connects the coupling 1 to the handle member 8 by means of inserting the fixing section 111 into the cave end 821 of the handle member 8. Second, he holds the handle member 8 such that the gap 123 of the first detaining side 12 tilts at an angle. Third, he passes the first detaining side 12 into one of the through holes 21 of the first board-shaped material 2, and turns the coupling 1 such that the first detaining side 12 passes through the through hole 21; thus, the first and the second detaining sides 12 and 13 are tightly pressed against respective ones of two sides of the first board-shaped material 2; the through holes 21 have a greater size than the radial cross section of the fastening section 112 therefore the coupling 1 can be moved within the corresponding through hole 21. Fourth, the handle member 8 is separated from the fixing section 111 of the coupling 1. Finally, the coupling 1 is inserted into one of the holding hole 31 of the second board-shaped material 3 from the fixing section 111; the flat ringed parts 14 are slightly wider than the holding holes 31 therefore the coupling 1 can't be easily separated from the second board-shaped material 3. The smaller the acute angle gap 123 of the first detaining side 12 is, the less likely the first board-shaped material 2 will separate from the coupling 1. Further, several couplings of the kind are used to couple the first and the second board-shaped materials 2 and 3, each of which is connected to one of the through holes 21 at the fastening section 112, and connected to one of the holding holes 31 at the fixing section 111 thereof; thus, the first and the second board-shaped materials 2 are securely joined together. From the above description, it can be easily seen that the thickness of the first board-shaped material 2 should be equal to the distance between the first and the second detaining sides 12 and 13 of the coupling 1.

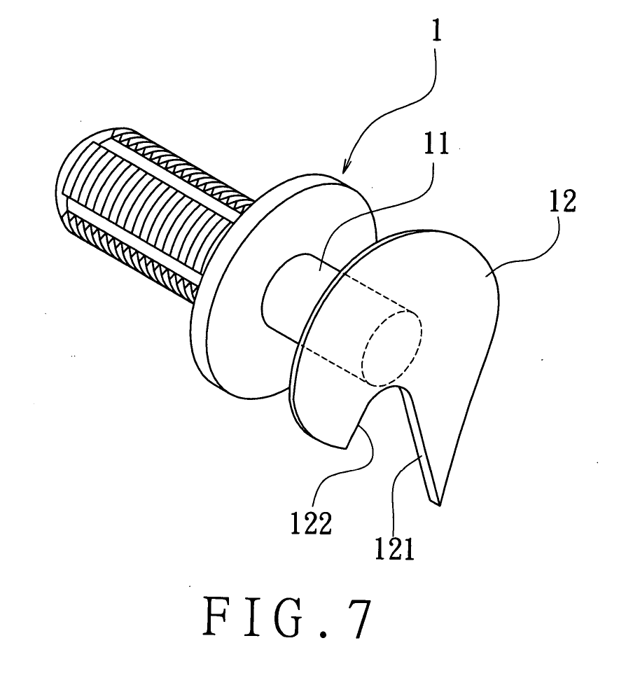

Referring to FIGS. 3 and 7, a modification is made to the first preferred embodiment, in which the belt-shaped plate part of the first detaining side 12 encompasses the post-shaped part 11 in a spiral shape, with the first and the second ends 121 and 122 thereof being at different distances from the second detaining side 13. Therefore, the coupling 1 will be more smoothly passed through the through hole 21 of the first board-shaped material 2 by means of turning the coupling 1 relative to the first board-shaped material 2 after the first detaining side 12 has been passed into the through hole 21.

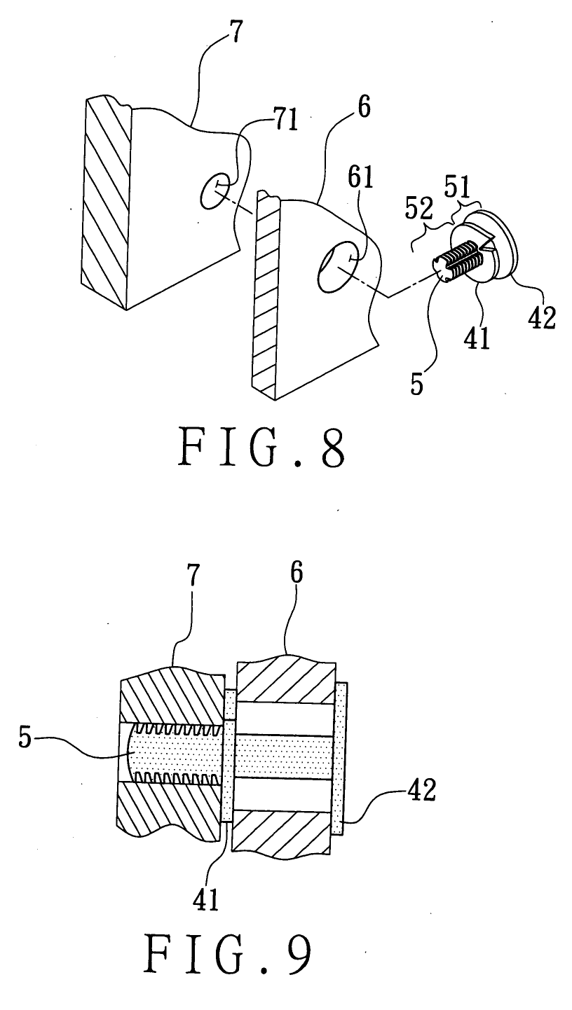

Referring to FIGS. 8 and 9, a second preferred embodiment of a coupling in the present invention is basically the same as the first one except that the first detaining side 12 is formed on the joined between the fixing section 111 and the fastening section 112, and the second detaining side 13 is formed on one end of the fastening section 112 that is apart from the fixing section 111; the second preferred embodiment has a post-shaped part 5, a first detaining side 41 on an intermediate portion of the post-shaped part 5, a second detaining side 42 on a tail end of the post-shaped part 5, and the post-shaped part 5 is divided into a fixing section 52, and a fastening section 51, which is between the first and the second detaining sides 41 and 42. In assembly, first the fixing section 52 and the first detaining side 41 of the coupling are passed through one of through holes 61 of a first board-shaped material 6, and next the coupling is turned such that the first detaining side 41 passes through the through hole 61; thus, the first and the second detaining sides 41 and 42 are tightly pressed against respective ones of two sides of the first board-shaped material 6. Finally, the fixing section 52 of the coupling is inserted into one of holding holes 71 of a second board-shaped material 7.

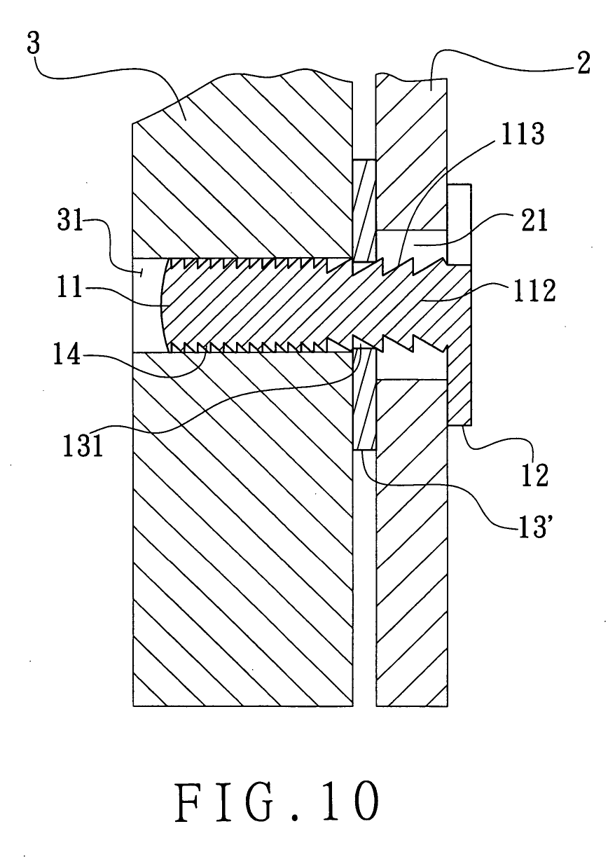

Referring to FIG. 10, a third preferred embodiment of the present invention has a post-shaped part 11, a first detaining side 12 joined to one end of the post-shaped part 11, and a second detaining side 13′; the post-shaped part 11 and the first detaining side 12 together are in the shape of a “T”; the post-shaped part 11 has a fastening section 112 having teeth 113 formed thereon; the second detaining side 13′ is separable from the post-shaped part 11, and it has a through hole 131 for the fastening section 112 of the post-shaped part 11 to pass through; the teeth 113 will engage the second detaining side 13′ when the fastening section 112 is passed into the through hole 131.

In joining first and second board-shaped materials 2 and 3 together, the post-shaped part 11 is passed through a through hole 21 of the first board-shaped material 2, and the through hole 131 of the second detaining side 13′, and next it is tightly fitted into a holding hole 31 of the second board-shaped material 3; thus, the first and the second board-shaped materials 2 and 3 are secured together.

The above couplings are made of plastic materials, and each have only one part formed by means of injection molding according to the present invention. However, the materials used can be other kinds of substances.

From the above description, it can be easily seen that the coupling structure of board-shaped materials in the present invention has the following advantages:

1. The through holes on the first board-shaped material, which are provided for the couplings of the present invention to pass through, are smaller than the holding holes, which are formed on the second board-shaped material of the conventional coupling structure for receiving the currently existing couplings. Therefore, the board-shaped materials of the coupling structure of the present invention have more strength, and there is no risk of the board-shaped materials cracking owing to existence of the through holes thereon. Furthermore, the couplings can be adjusted in position within the holes of the first board-shaped material therefore they can be easily centered on the holding holes of the second board-shaped material in assembly.

2. The whole body of each coupling of the present invention is formed in an injection molding process therefore the couplings have simpler structure and lower manufacturing cost. And, the couplings don't have to be used together with staples therefore they can be easily and rapidly fitted on a board-shaped material.

3. The second detaining side of the coupling of the third preferred embodiment can be adjusted in position in relation to the post-shaped part therefore the coupling can be used on board-shaped materials within a certain thickness range. In other words, the use of the coupling isn't limited to a certain fixed board-shaped material thickness.

What is claimed is:

1. A coupling for joining board-shaped materials, comprising
a post-shaped part; the post-shaped part including a fixing section, and a fastening section; the fixing section having a plurality of flat ringed parts encompassing and spaced along it;
a first detaining side on a first end of the fastening section of the post-shaped part; the first detaining side including a belt-shaped plate part, which encompasses the post-shaped part, and which has first and second ends; a gap existing between the first and the second ends of the first detaining side;
a second detaining side on a second end of the fastening section of the post-shaped part; and
a holding space between the first and the second detaining sides;
the first detaining side and the fastening section of the coupling being passed through one through hole of a first board-shaped material until the first and the second detaining sides are tightly pressed against two sides of the first board-shaped material respectively such that the coupling is secured to the first board-shaped material; the coupling being inserted into one holding hole of a second board-shaped material at the fixing section to fasten the first board-shaped material to the second board-shaped material; the flat ringed parts of the post-shaped part being slightly wider than the holding hole of the second board-shaped material.

2. The coupling for joining board-shaped materials as claimed in claim 1, wherein each of the encompassing flat ringed parts on the fixing section of the post-shaped part has a plurality of gaps thereon, and in turn the coupling has a plurality of axial trenches thereon.

3. The coupling for joining board-shaped materials as claimed in claim 2, wherein number of the axial trenches is four.

4. The coupling for joining board-shaped materials as claimed in claim 1, wherein the gap between the first and the second ends of the first detaining side is an acute angle.

5. The coupling for joining board-shaped materials as claimed in claim 1, wherein the first end of the belt-shaped plate part of the first detaining side has a greater width than the second end.

6. The coupling for joining board-shaped materials as claimed in claim 1, wherein the through hole of the first board-shaped material has a greater size than a radial cross section of the fastening section of the post-shaped part.

7. The coupling for joining board-shaped materials as claimed in claim 1, wherein the second detaining side is flat ring-shaped, and it encompasses the post-shaped part.

8. The coupling for joining board-shaped materials as claimed in claim 1, wherein the belt-shaped plate part of the first detaining side encompasses the post-shaped part in a spiral manner.

9. The coupling for joining board-shaped materials as claimed in claim 1 being further equipped with a handle member, which includes a grip portion, and a connecting portion having a cave end for allowing the fixing section of the post-shaped part to be inserted into.

10. The coupling for joining board-shaped materials as claimed in claim 1, wherein the post-shaped part and the first detaining side together are in the shape of a “T”, and the second detaining side is separable from the post-shaped part, and has a through hole; the fastening section of the post-shaped part has plural teeth thereon, which will engage the second detaining side when the fastening section is passed into the through hole of the second detaining side.
